(19) United States
(12) Patent Application Publication
(10) Pub. No.: US 2005/0107934 A1
(43) Pub. Date: May 19, 2005

(54) Work site tracking system and method

(75) Inventors: Adam J. Gudat, Chillicothe, IL (US); Robert A. Horkavi, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/912,311

(22) Filed: Aug. 6, 2004

Related U.S. Application Data
(60) Provisional application No. 60/523,503, filed on Nov. 18, 2003.

(51) Int. Cl. G01S 1/00; G01C 21/26

(52) U.S. Cl. 701/50; 342/357.07; 701/213

(57) ABSTRACT

A positioning system for an entity at a work site may include an RFID device including a memory configured to store a position of the entity and at least one other characteristic associated with the entity. A transmitter associated with the RFID device can emit a signal including information relating to the position of the entity and to the at least one other characteristic of the entity.

This application claims the benefit of U.S. Provisional Application No. 60/523,503, filed Nov. 18, 2003, which is incorporated herein by reference.

### TECHNICAL FIELD

The present disclosure relates to the field of work site management systems and methods, and more particularly, to systems and methods for tracking entities at a work site.

### BACKGROUND

Workers at work sites, including construction and/or mining sites, may experience dangers from several elements. For example, these sites typically include heavy machinery and equipment, such as bulldozers, cranes, front wheel loaders, soil stabilizers, rippers, and pulverizers. Operators of such heavy machinery and equipment often have a limited field of vision and may not readily detect the presence of other entities (e.g., workers, structures, and/or other machines) at the work site. The lack of knowledge regarding the presence and location of workers and other machines at the work site can lead to accidental collisions. Thus, there is a need for a system of locating and tracking the positions of workers, machines, hazardous sites, infrastructure elements, and other work site obstacles and displaying the positions of these obstacles to the machine operators.

Various systems have been proposed for tracking obstacles at work sites. U.S. Pat. No. 6,614,721 to Bokohour (“the '721 patent”) describes one example of a collision avoidance system including a reader device attached to a vehicle. The reader device periodically transmits an ultrasonic pulse. If within range of the ultrasonic pulse, a tag device, worn by a worker or positioned on a machine or obstacle, receives the ultrasonic pulse and transmits a radio frequency (RF) signal to an RF receiver associated with the reader device.

A distance between the vehicle and the worker or obstacle in the '721 patent may be determined by monitoring the elapsed time between the transmission of the ultrasonic pulse and the reception of the corresponding RF signal. While the system of the '721 patent may potentially enable tracking of entities within a certain envelope of operation, the system may suffer from several shortcomings. For example, discerning an exact position (e.g., azimuth and distance) of the tracked entity with respect to the reader may be difficult or impossible. Further, the ultrasonic waves used to monitor the distance to a tracked entity may be vulnerable to interference. The system may also be ineffective at operating in all conditions that may be present at a work site.

The present disclosure addresses one or more of the deficiencies in the prior art.

### SUMMARY OF THE INVENTION

One disclosed embodiment includes a positioning system for an entity at a work site. The positioning system may include an RFID device including a memory configured to store a position of the entity and at least one other characteristic associated with the entity. A transmitter associated with the RFID device can emit a signal including information relating to the position of the entity and to the at least one other characteristic of the entity.

Another disclosed embodiment includes a work machine having a body and an antenna operably connected to the body. The antenna may be configured to receive a signal emitted by an RFID device associated with at least one entity located remotely from the work machine. The work machine may also include a controller configured to determine a position of the at least one entity based on the signal received by the antenna and determine at least one other characteristic associated with the at least one entity based on the signal received by the antenna.

Another disclosed embodiment includes a work site management system. The system includes a network interface configured to receive signals transmitted by a plurality of entities at one or more work sites, each of the received signals including information relating to a position and at least one other characteristic of at least one of the plurality of entities. A controller may be configured to identify a transmitting entity from among the plurality of entities and locate the transmitting entity with respect to the plurality of entities based on the information in the received signals. A display may be configured to display a location of the transmitting entity with respect to the plurality of entities at the one or more work sites.

Another disclosed embodiment includes a method of tracking an entity at a work site. The method may include receiving a signal transmitted from at least one entity at the work site, the signal including information relating to a position of the at least one entity and at least one other characteristic of the at least one entity. The position of the at least one entity relative to at least one other entity at the work site can be determined, and the position of the at least one entity may be displayed on a display.

### BRIEF DESCRIPTION OF THE DRAWINGS

FIG. 1 is a schematic top-view representation of a work machine including an exemplary disclosed tracking system.

FIG. 2 is a schematic representation of an exemplary disclosed RFID device.

FIG. 3 is a block diagram representation of a tracking system in accordance with an exemplary disclosed embodiment.

FIG. 4 is a block diagram representation of a work site management system according to an exemplary disclosed embodiment.

FIG. 5 is a block diagram illustrating an exemplary work site management station according to an exemplary disclosed embodiment.

FIG. 6 is flow chart representative of an exemplary disclosed method for tracking an entity at a work site.

### DETAILED DESCRIPTION

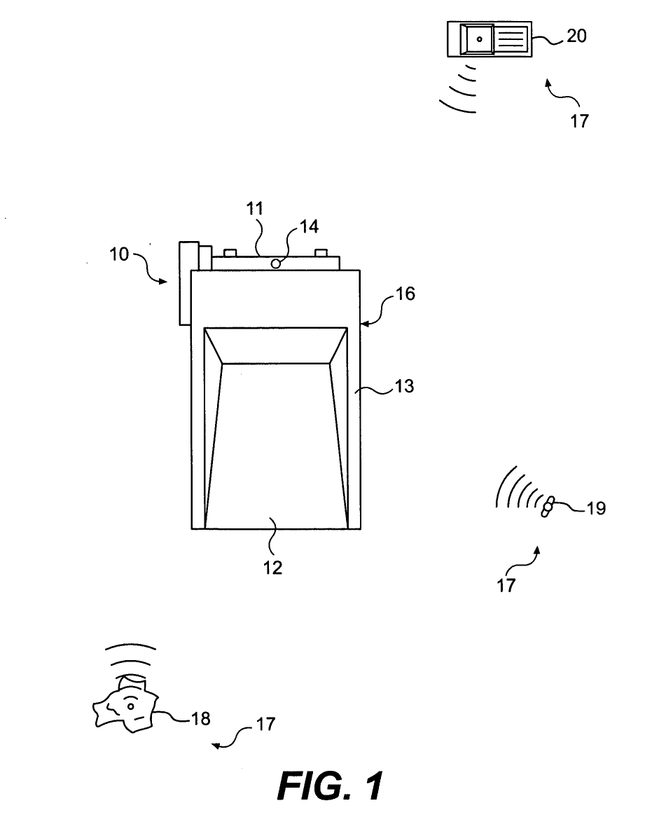

FIG. 1 provides a schematic top-view illustration of a work machine 10 according to an exemplary disclosed embodiment. Work machine 10 may include a truck, wheel loader, track-type tractor, wheeled tractor, vehicle, or any other type of machine known in the art. As used herein the terms “vehicle,” “machine,” and “equipment” are interchangeable, and by way of non-limiting examples, may refer to any equipment that may be used in any vehicular, construction, mining, work site, or other machine-related capacity.

As illustrated in FIG. 1, work machine 10 may include a dump truck having a front end 11 and a load carrying area 12. Work machine 10 may also include a body 13 onto which a tracking antenna 14 may be mounted. In one embodiment, work machine 10 may include only a single tracking antenna 14 that can be mounted, for example, on a top portion of work machine 10. In this configuration, tracking antenna 14 may have an unobstructed field of view of the work site and may receive signal transmissions from any direction relative to work machine 10. Thus, as shown in FIG. 1, tracking antenna 14 may provide a substantially 360 degree field of detection around work machine 10.

In another embodiment, work machine 10 may include a plurality of tracking antennas located at various positions on work machine 10. Each antenna may include a predefined tracking area with respect to work machine 10. In certain configurations, the tracking areas associated with each of the tracking antennas may be combined such that the plurality of tracking antennas may provide up to a 360 degree field of detection around work machine 10.

Tracking antenna 14 may include various types of antennas. In one embodiment, tracking antenna 14 may include a dipole antenna, and in another embodiment, antenna 14 may include a scanning antenna, such as a phased array antenna. A scanning antenna may be used to direct a focused beam in a desired direction and to scan the beam over a range of angles.

Tracking antenna 14 may have several functions. For example, tracking antenna 14 may receive signals transmitted by a tracked entity 17 at a work site. For purposes of this disclosure, a tracked entity includes any entity whose position and/or other characteristics are monitored by at least one other entity. A tracking entity 16 (e.g., work machine 10 in FIG. 1) includes any entity that monitors the position and/or other characteristics of at least one tracked entity. Tracked entity 17 may include any machine, vehicle, person, infrastructure, or other entity that may be found at a work site. For example, as shown in FIG. 1, tracked entity 17 may include a rock outcrop 18, a person 19, and/or a vehicle 20. The signals transmitted by the tracked entities may include information relating to a position of a particular tracked entity and various other characteristics of the tracked entity.

Tracking antenna 14 may also be used for communication with other tracking entities (e.g., other machines similar to work machine 10 that may themselves be tracking various entities at the work site). In certain embodiments, however, these types of communications between tracking entities may be accomplished by using one or more antennas or devices other than, and in addition to, tracking antenna 14.

Tracking antenna 14 may also be used for activation of passive transmitter devices associated with the tracked entities. For example, in response to an interrogation signal from tracking antenna 14, a passive transmitter may enter a “powered on” state and begin transmitting signals that can be received by tracking antenna 14. Additionally, a passive transmitter may be configured to absorb a portion of the signal energy supplied by tracking antenna 14 and use this energy to return a transmitted signal to tracking antenna 14.

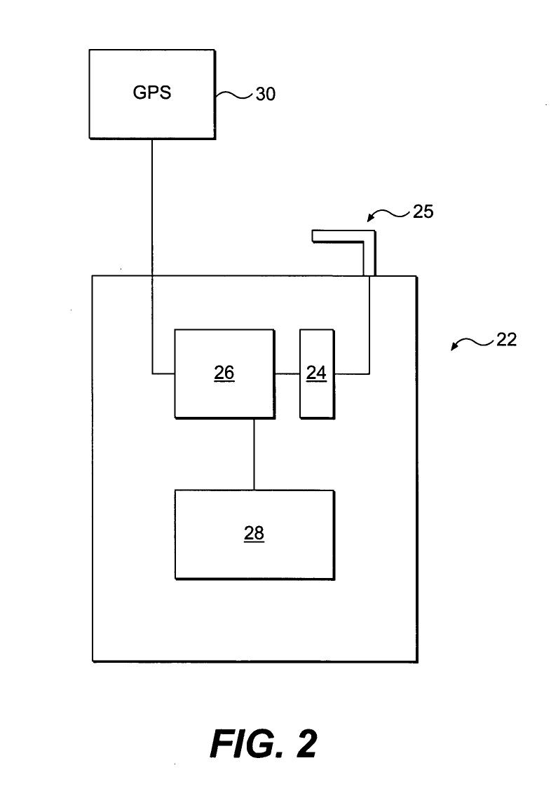

Signals transmitted by various tracked entities may enable tracking entities to determine the position and other characteristics of the tracked entity. In one embodiment, each tracked entity may include a radio frequency identification (RFID) device 22, as represented by FIG. 2. RFID device 22 may be configured as a tag that is attached to rock outcrop 18 or vehicle 20 or that may be worn by person 19.

RFID device 22 may include a variety of components configured for storing information relating to the characteristics of the tracked entity and for transmitting that information as a radio frequency signal. In one embodiment, RFID device 22 may include a transmitter 24, an antenna 25, a processor 26, and a memory 28. RFID device 22 may also be associated with a GPS receiver 30.

RFID device 22 may include data relating to the tracked entity in memory 28. For example, the position of the tracked entity may be stored in memory 28. The position information may be stored as latitude and longitude coordinates or as coordinates referenced to any desired reference point (e.g., a reference point located at a work site).

The position information may be supplied to memory 28 using a device located external to the tracked entity. In one embodiment, a keypad, laptop computer, information card, a barcode scanner, a remotely located computer in communication over a network, or any other suitable device for supplying position information to RFID device 22 may be used to input position data into memory 28. Using an external device to supply position information to memory 28 may be especially suited to an application where RFID device 22 is associated with a tracked entity at a fixed location. That is, for tracked entities that do not move, or move only sporadically, the position information in memory 28 may be written once and may not require updating until the tracked entity changes locations.

Alternatively, the tracked entity position information may be supplied to memory 28 using GPS receiver 30. In this embodiment, processor 26 may use data from GPS receiver 30 to update the position information stored in memory 28 on a real-time basis or at predetermined time intervals. GPS receiver 30 may be integrated with RFID device 22 or may be located on the tracked entity at a position separate from RFID device 22.

GPS receiver 30 may be included on either a tracked entity having a fixed location or one that moves. Including GPS receiver 30 on a tracked entity that moves, however, may be especially suitable for providing updates, with little delay, to the position information in memory 28.

In addition to position information, memory 28 may also be used for storing information relating to various characteristics of the tracked entity. In certain embodiments, the size, shape, and orientation of the tracked entity may be stored in memory 28. Further, memory 28 may include data indicating whether certain hazards or hazardous conditions exist on the tracked entity. For example, memory 28 may include data indicating that flammable liquids, high pressure fluids, and or hazardous geographic features are present on or at the tracked entity. The information in memory 28 may also specify additional details relating to the hazards present (e.g., size of cliff, type of flammable liquid, etc.). Other data stored in memory 28 may include a unique identification string, type, or name associated with the tracked entity. A velocity and heading direction associated with the tracked entity may also be stored, and periodically updated, in memory 28.

Transmitter 24 may emit a signal from RFID device 22 using antenna 25. This transmitted signal may include information relating to the position of the tracked entity and to at least one other characteristic of the tracked entity. For example, the transmitted signal may include all or part of the information stored in memory 28. Thus, not only will a receiver of the transmitted signal be able to determine the position of the tracked entity based on the position information from memory 28, but the receiver of the signal may also be able to determine the size, shape, orientation, name, velocity, etc. of the tracked entity.

Transmitter 24 may be a passive device that emits an RF signal when interrogated by a scanning signal (e.g., a beam radiated from tracking antenna 14). In this embodiment, transmitter 24 may behave as a transponder that powers on and emits a signal only when interrogated by the scanning signal. In another embodiment, transmitter 24 may include a passive device that can absorb energy from a scanning signal and re-transmit that energy as a transmitted RF signal. Alternatively, transmitter 24 may also include an active device that emits an RF signal when in a powered-on state regardless of the presence of a scanning signal. In this embodiment, transmitter 24 may be provided with a continuous source of power and would behave as a beacon that emits a signal as long as it receives that power. Other types of RFID tags and/or transmitters may be appropriate depending on the requirements of a particular application.

In one embodiment, an RFID device 22 having an active transmitter 24 may be associated with tracked entities that move. Certain active transmitters may have a shorter response time compared to passive transmitters and, therefore, may be appropriate for use in tracking entities whose position information may change rapidly over time. Also, active transmitting devices may provide a longer transmission range than passive transmitting devices, which can be useful in tracking moving entities. Particularly, a longer transmission range may enable earlier detection of a moving entity and provide additional time to, for example, avoid a potential collision with the moving entity. It should be noted that tracking moving entities is not limited to the use of active transmitting devices. Rather, depending on the requirements of a particular application, either active devices or passive devices may be used to track both moving and stationary entities.

Returning to FIG. 1, work machine 10 may function as a tracking entity 16 that monitors the positions and other characteristics of tracked entities 17 (e.g., rock outcrop 18, person 19, vehicle 20, etc.) In addition to its role as tracking entity 16, work machine 10 may constitute a tracked entity. Specifically, work machine 10 may include an RFID device 22 (FIG. 2) that enables other tracking devices to determine the position and other characteristics associated with work machine 10.

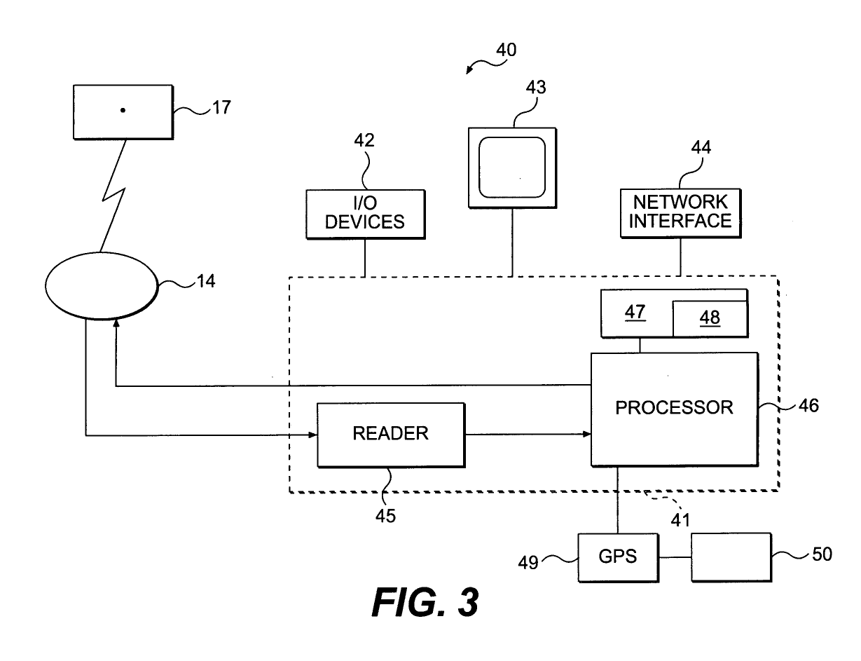

FIG. 3 provides a block diagram representation of a tracking system 40 that may be included on work machine 10. Tracking system 40 may include antenna 14, as described above, configured to receive a signal transmitted by one or more tracked entities 17. Tracking system 40 may also include a controller 41, various input/output devices 42, a display 43, and a network interface 44.

Controller 41 may be associated with or include a variety of components such as, for example, a reader 45, a processor 46, and a memory 47. Controller 41 may include any additional components known in the art for receiving data, running applications, and/or issuing control signals. It is contemplated that controller 41 may be located on work machine 10 or at a site remote from work machine 10.

Memory 47 may include a control module 48, which may provide functionality associated with controller 41 and tracking system 40. Control module 48 may include a software module, a hardware circuit, or a combination of software modules and hardware circuits. Further, functionality associated with control module 48 may be distributed into sub-components.

Display 43 may be located on work machine 10. In one embodiment, display 43 may provide a graphical representation of work machine 10 and/or an area surrounding work machine 10. The locations, sizes, shapes, and any another other suitable characteristics of various tracked entities located in the area surrounding work machine 10 may be displayed to an operator of work machine 10 on display 43. Display 43 may include an LCD, a CRT, or any other display known in the art.

Network interface 44 may enable communication between controller 41 and various control systems or communication links remotely located with respect to work machine 10. For example, network interface 44 may provide a wired or wireless link to a LAN, a WAN, the Internet, one or more portable computing devices, or any other suitable network or device for exchanging information with controller 41. Network interface 44 may communicate information relating to work machine 10 or any tracked entity 17 monitored by work machine 10 to a work site management station, which will be described below.

Reader 45 may be included in tracking system 40 for monitoring signals received by antenna 14. For example, reader 45 may demodulate RF signals transmitted by tracked entities 17 and format the information included in those signals. Reader 45 may also recognize information related to identification and other characteristics of tracked entities 17, as described above, that is contained within the signals received by antenna 14. This information may be passed to processor 46 and/or stored in memory 47.

Processor 46 may provide control signals to antenna 14. These control signals may place antenna 14 in a receiving mode capable of receiving signals transmitted by tracked entities 17. Also, in a configuration where antenna 14 includes a scanning antenna, the control signals provided by processor 46 may control the beam shape, scanning rate, signal strength, scanning area, or any other characteristic of the scanning beam emitted from antenna 14. Processor 46 may also be responsible for processing data received from tracked entities 17 and for communicating with various systems on and off work machine 10.

Tracking system 40 can determine the relative position of one or more tracked entities 17 with respect to work machine 10. For example, signals transmitted by tracked entities 17 and received by antenna 14 include position information, which may be supplied by an associated GPS receiver and/or a memory associated with each tracked entity 17. Based on the position information included in the signals transmitted by tracked entities 17, controller 41 may locate each of tracked entities 17 with respect to known position coordinates of work machine 10. The known position coordinates of work machine 10 may be supplied, and continuously updated, by a GPS receiver 49 associated with work machine 10. Information from GPS receiver 49 may be supplied to an RFID device 50, which may enable other entities to track the position and other characteristics of work machine 10.

By comparing position coordinates of each tracked entity 17 with respect to position coordinates of work machine 10, using compatible coordinate systems or systems having a common reference point, controller 41 can determine both a distance and an azimuth value between each tracked entity 17 and work machine 10. As work machine 10 traverses a work site, controller 41 may update the relative locations of each tracked entity 17 with respect to work machine 10. This information can be displayed to an operator of work machine 10, for example, on display 43.

Additional information included in the signals transmitted by tracked entities 17 may help a receiver of this information better evaluate potentially hazardous situations. For example, information relating to the type, size, shape, and orientation of tracked entity 17 and/or whether certain hazards or hazardous conditions are associated with tracked entity 17 may be displayed on display 43. This information may enable an operator of work machine 10, for example, to aid in avoiding a collision with any of tracked entities 17 and to evaluate the risks associated with a potential collision with any of tracked entities 17.

Controller 41 may be further configured to monitor a change in the relative position of each of tracked entities 17 with respect to the position of work machine 10. Determining this change in relative position may be accomplished by observing a change in the position information transmitted by each of tracked entity 17, observing a change in the position of work machine 10, and determining a new relative position between each of tracked entities 17 and work machine 10. Alternatively, the change in relative position between each tracked entity 17 and work machine 10 may be determined using velocity data for each tracked entity 17 that may be transmitted along with its position information.

Using either of these methods, or any other appropriate method for monitoring changes in relative position, controller 41 may determine a likelihood of a collision between the any of tracked entities 17 and work machine 10. If controller 41 determines that the potential collision may occur within a certain predetermined time value or within a predetermined distance from work machine 10, controller 41 may issue a warning signal (e.g., an audible warning or a graphical warning, for example, on display 43).

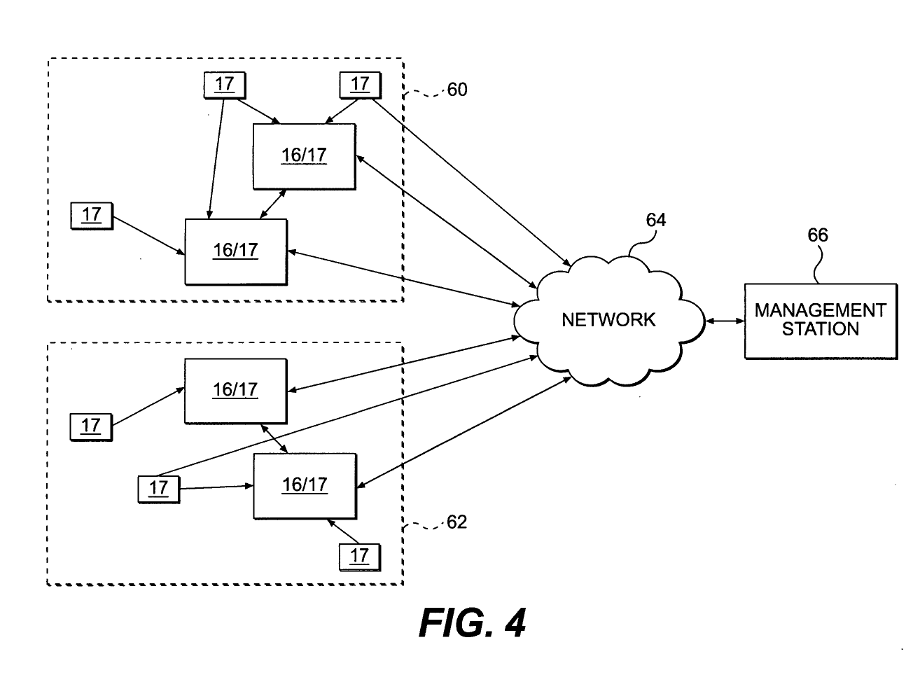

FIG. 4 provides a schematic illustration of a communication system arrangement consistent with the disclosed tracking system. In one embodiment, one or more tracking/tracked entities 16/17 (i.e., tracking entities 16 that may also be tracked by another entity) and one or more tracked entities 17 may be included at a first work site 60. Similarly, one or more tracking/tracked entities 16/17 and one or more tracked entities 17 may be included at a second work site 62. At each work site, communications in the form of transmitted signals, for example, may be relayed from tracked entities 17 to either tracking/tracked entities 16/17 or over a network 64 to work site management station 66. Further, each tracking/tracked entity 16/17 may communicate with one or more other tracking/tracked entities 16/17 or over network 64 to work site management station 66.

Network 64 may include any appropriate network for transferring information between entities at work sites 60, 62 and work site management station 66. In one embodiment, network 64 may include one or more wireless networks. Network 64 may also include one or more modem links, repeater stations, gateway units, access points, or any other network devices.

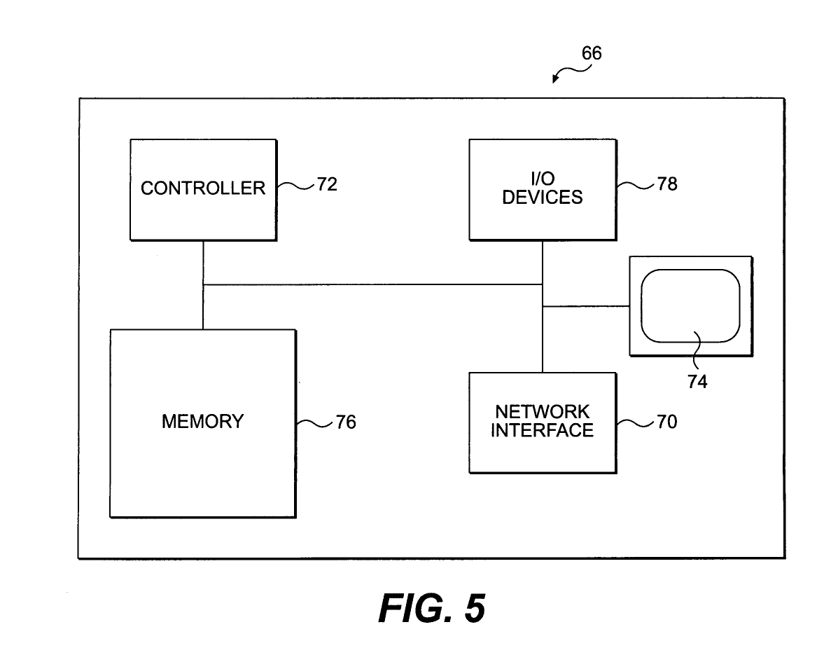

FIG. 5 illustrates a schematic block level diagram of work site management station 66 consistent with an exemplary embodiment. Management station 66 may include a network interface 70 configured to receive signals transmitted by a plurality of entities (e.g., tracking entities 16, tracked entities 17, and/or tracking/tracked entities 16/17) at one or more work sites. Each of the signals received over network interface 70 may include information relating to a position and at least one other characteristic of the plurality of entities. Network interface 70 may include a wireless link, such as an antenna, transceiver, or other wireless system device, one or more modem connections, or any other device for communicating with network 64 (FIG. 4).

Management station 66 may also include a controller 72 configured to monitor received signals and identify the sending entity based on information included in the received signals. Further, based on these received signals, controller 72 may locate the transmitting entity and determine a position of the transmitting entity with respect to a particular work site.

Management station 66 may include a display 74 configured to display the locations of the transmitting entities at their respective work sites. A memory 76 may also be included in management station 66. Controller 72 may be configured to maintain a database in a memory 76 that includes positions and characteristics of entities at a plurality of work sites. Work site management station 66 may also include a plurality of I/O devices 78 that may be used to convey information relating to entities at the monitored work sites to operators of management station 66 or to a location remote from work station 66.

Controller 72 may be configured to monitor the relative positions of various entities at one or more work sites. Based on changes in these relative positions, controller 72 may determine whether a potential exists for collisions between any of the entities at the work sites. If a potential collision condition is found to exist, controller 72 may issue a warning signal if the potential collision will occur within a certain predetermined time value or within a certain predetermined distance from work machine 10. The warning signal may be communicated to the appropriate entities via network interface 70 and network 64. Controller 72 may further be configured to issue one or more control signals to appropriate entities at the work sites to cause a change in motion of one or more of the entities for which a potential collision has been determined.

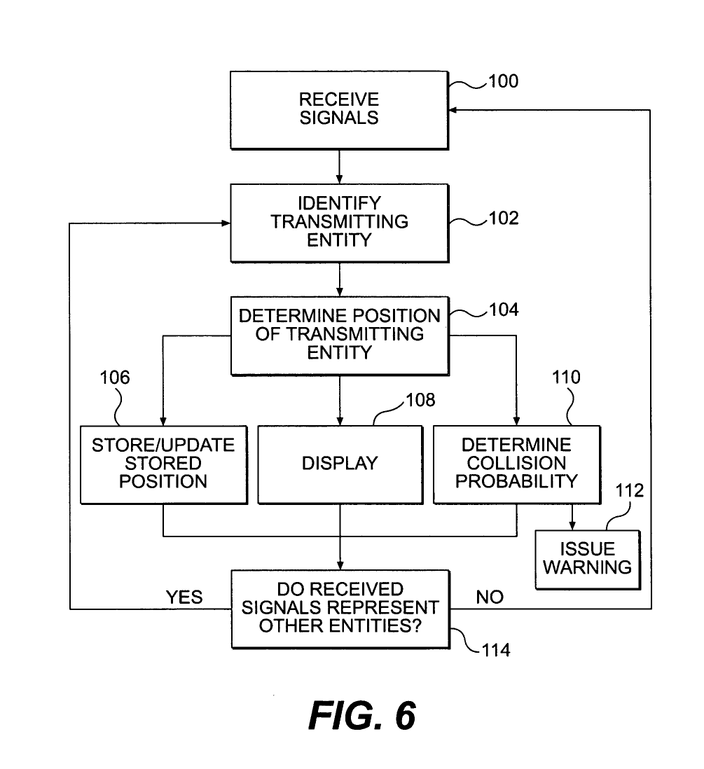

FIG. 6 provides a flow chart illustrating a method of tracking entities a work site. The method may be performed, for example, by controller 41 associated with work machine 10 or by controller 72 associated with work site management station 66. At step 100, signals may be received by one or more entities at a work site. These signals may be transmitted by an RFID device or by any other suitable transmitting device. At step 102, a first transmitted signal from the signals received at step 100 may be examined to identify the source of the transmitted signal. For example, the transmitted signal may include a name, string, identification tag code, number, or other identification element unique to the transmitting entity. At step 104, the position of the transmitting entity may be determined based on position information included in the transmitted signal. This position information may be supplied by a GPS receiver associated with the transmitting entity or by a memory that includes prestored position information for the transmitting entity. The position information determined at step 104 may be stored in a database in a memory or used to update information stored in the memory, at step 106. The position information may be graphically displayed at step 108, and a probability of a collision occurring between two or more entities at a work site may be determined at step 110. If a collision is determined to occur within a certain predetermined time interval (or within a predetermined distance), a warning signal may be issued at step 112. Finally, at step 114, the signals received at step 100 may be examined to determine whether the signals represent additional entities at a work site. If so, the method may be repeated beginning at step 102. If not, then the method may return to step 100 to await the reception of one or more transmitted signals.

### Industrial Applicability

The disclosed systems and methods for tracking entities may be used in any application where there is a need for monitoring the relative positions of objects. For example, the disclosed tracking systems may be employed at a work site, such as a construction or a mining site, to enable monitoring of relative positions between equipment, structures, vehicles, people, and any other type of entity at the work site. The disclosed systems may be helpful to entities at a work site in avoiding collisions with other entities at the work site. The disclosed systems may be especially useful for providing information relating to the presence of entities in blind spots of a work machine operated at a work site.

The disclosed systems may also function as part of an inventory system at a work site or other location. For example, as a tracking entity traverses a work site, it may receive signals transmitted from various tracked entities. Because these signals may include information relating to the position of the tracked entity and various other characteristics, each tracking entity can maintain a database that includes the position of each tracked entity encountered along with other identifying characteristics for each tracked entity. The information in this database, and corresponding databases in other tracking entities, may be communicated to a work site management station where a global inventory database of all tracked entities can be maintained.

Additionally, the disclosed systems may provide for a simple, reliable, and accurate method for determining range information between entities at a work site. For example, because the position information of a tracked entity is transmitted directly to a tracking entity using, for example, an RFID device associated with a GPS receiver or a memory including prestored position information, the tracking entity can precisely locate the tracked entity without the uncertainty that may be caused by sensor-generated errors.

It will be apparent to those skilled in the art that various modifications and variations can be made in the disclosed entity tracking systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

1. A positioning system for an entity at a work site, comprising:
an RFID device including a memory configured to store a position of the entity and at least one other characteristic associated with the entity; and
a transmitter associated with the RFID device that emits a signal including information relating to the position of the entity and to the at least one other characteristic of the entity.

2. The positioning system of claim 1, wherein the at least one other characteristic includes at least one of a size, shape, orientation, an indication of hazards present, identification string, type, name, velocity, and heading associated with the at least one entity.

3. The positioning system of claim 1, further including:
a GPS receiver;
wherein the position of the entity stored in the memory is provided by the GPS receiver.

4. The positioning system of claim 1, wherein the entity has a fixed location with respect to the work site and the position of the entity stored in the memory is written into the memory using a device external to the entity.

5. The positioning system of claim 1, wherein the RFID device is a passive device.

6. The positioning system of claim 1, wherein the RFID device is an active device.

7. A work machine comprising:
a body;
an antenna operably connected to the body, the antenna configured to receive a signal emitted by an RFID device associated with at least one entity located remotely from the work machine; and
a controller, wherein the controller is configured to:
determine a position of the at least one entity based on the signal received by the antenna; and
determine at least one other characteristic associated with the at least one entity based on the signal received by the antenna.

8. The work machine of claim 7, further including:
a GPS receiver; and
a display,
wherein the controller is further configured to determine a position of the work machine based on a signal provided by the GPS receiver and display the position of the work machine relative to the position of the at least one entity on the display.

9. The work machine of claim 8, wherein the controller is further configured to:
monitor a change in the position of the at least one entity with respect to the position of the work machine;
determine a likelihood of a collision between the at least one entity and the work machine; and
issue a warning signal if the collision is determined to occur within a certain predetermined time value or a predetermined distance.

10. The work machine of claim 7, wherein the antenna includes a phased array antenna.

11. The work machine of claim 7, wherein the antenna includes a dipole antenna.

12. The work machine of claim 7, wherein the at least one other characteristic associated with the at least one entity includes one or more of a size, shape, orientation, an indication of hazards present, identification string, type, name, velocity, and heading associated with the at least one entity.

13. The work machine of claim 7, further including:
a network interface configured to forward the position of the work machine, the position of the at least one entity, and the at least one other characteristic associated with the at least one entity to a network associated with a work site control system.

14. The work machine of claim 7, further including:
an RFID device associated with the work machine, the RFID device being configured to transmit information relating to a position of the work machine and at least one other characteristic of the work machine.

15. A work site management system comprising:
a network interface configured to receive signals transmitted by a plurality of entities at one or more work sites, each of the received signals including information relating to a position and at least one other characteristic of at least one of the plurality of entities;
a controller configured to identify a transmitting entity from among the plurality of entities and locate the transmitting entity with respect to the plurality of entities based on the information in the received signals; and
a display configured to display a location of the transmitting entity with respect to the plurality of entities at the one or more work sites.

16. The work site management system of claim 15, further including a memory, and
wherein the controller is further configured to maintain a database of identified entities and their corresponding positions at the one or more work sites in the memory.

17. The work site management system of claim 15, wherein the transmitting entity is a tracked entity located at a fixed location on the one or more work sites, and the tracked entity includes an RFID device that stores and transmits position information relating to the fixed location.

18. The work site management system of claim 15, wherein the transmitting entity includes at least one of a tracked entity and a tracking entity at the one or more work sites, and the at least one of the tracked entity and the tracking entity includes an RFID device that stores and transmits position information provided by an associated GPS receiver.

19. The work site management system of claim 15, wherein the at least one additional characteristic includes at least one of a size, shape, orientation, an indication of hazards present, identification string, type, name, velocity, and heading associated with the at least one of the plurality of entities.

20. The work site management system of claim 15, wherein the network interface includes a wireless transceiver.

21. The work site management system of claim 15, wherein the controller is further configured to determine a likelihood of a collision between any of the plurality of entities; and
issue a warning signal if the collision is determined to occur within a certain predetermined time value or a predetermined distance.

22. A method of tracking an entity at a work site comprising:
receiving a signal transmitted from at least one entity at the work site, the signal including information relating to a position of the at least one entity and at least one other characteristic of the at least one entity;
determining the position of the at least one entity relative to at least on other entity at the work site; and
displaying the position of the at least one entity on a display.

23. The method of claim 22, wherein the signal is transmitted from an RFID device associated with the at least one entity.

24. The method of claim 23, wherein the information relating to the position of the at least one entity is provided to the RFID device by an associated GPS receiver.

25. The method of claim 22, further including:
determining a likelihood of a collision between the at least one entity and the at least one other entity; and
issuing a warning signal if the collision is determined to occur within a certain predetermined time value or a predetermined distance.
